(19) United States
(12) Patent Application Publication
(10) Pub. No.: US 2025/0266627 A1
(43) Pub. Date: Aug. 21, 2025

(54) EARTHING CONNECTION DEVICE

(71) Applicants: Aron von Schéele, Malmö (SE); Pascal Deus, Bottrop (DE)

(72) Inventors: Aron von Schéele, Malmö (SE); Pascal Deus, Bottrop (DE)

(73) Assignee: RWE Offshore Wind GmbH, Essen (DE)

(21) Appl. No.: 19/200,111

(22) Filed: May 6, 2025

Related U.S. Application Data
(63) Continuation of application No. PCT/EP2022/080963, filed on Nov. 7, 2022.

(51) Int. Cl. H01R 4/66; B63B 35/44; H01B 7/14

(52) U.S. Cl. CPC H01R 4/66; B63B 35/44; B63B 2209/00; H01B 7/14

(57) ABSTRACT

An earthing connection device for an earthing system of an offshore structure includes at least one earthing connector configured to be inserted in an underwater ground in an installed state of the earthing connection device. At least one electrical connector is electrically connected to the at least one earthing connector. The least one electrical connector is configured to connect the electrical connector with at least one armoring wire of at least one armoring layer of the submarine cable.

### CROSS-REFERENCE TO RELATED PATENT APPLICATIONS

This patent application is a continuation of International Application No. PCT/EP2022/080963, filed on Nov. 7, 2022, the entire teachings and disclosures are incorporated herein by reference thereto.

### FIELD OF THE INVENTION

The application relates to an earthing connection device for an earthing system of an offshore structure. Further, the application relates to an earthing set, an offshore structure, an offshore structure system, a use and an installation method.

### BACKGROUND OF THE INVENTION

In the present time, power generation systems are increasingly used for the provision of electrical energy, in which the generation of electrical energy is based on so-called renewable energy sources. Electric power generation systems have at least one power generation device, preferably a plurality of power generation devices.

For example, wind energy systems and wind farms, respectively, comprising at least one wind turbine as an energy generation device are used as electrical energy generation systems. In particular, a wind turbine is configured to convert the kinetic wind energy into electrical energy. In addition to wind farms, photovoltaic systems and photovoltaic farms, respectively, are also increasingly constructed as electrical energy generation systems, in which a plurality of photovoltaic modules are generally provided for electrical energy generation.

Such power generation systems are not only located at onshore sites, but increasingly also at offshore sites. There are many reasons for choosing an offshore site: for example, the available space onshore may be limited. In addition, it has been shown that the energy yield can be increased at wind farms, for example. Offshore locations are usually characterized by relatively continuous wind conditions and high average wind speeds, so that offshore wind farms are increasingly being built. Offshore photovoltaic farms, for example, may be installed due to space constraints.

Typically, an offshore structure system has a plurality of (stationary) offshore structures (i.e., no ships or the like), such as a plurality of offshore wind turbines and at least one offshore substation (also called converter station) by which the offshore structure system in form of an offshore wind farm can be electrically connected, for example, to an onshore substation or a further offshore substation.

An onshore substation, in turn, may be connected to a public power grid. In order to transmit electrical power between two offshore structures or an offshore structure and an onshore structure, power cables in the form of submarine power cables are laid between said structures.

While it has been common practice so far for wind turbines and offshore substations, but also for other offshore structures, such as photovoltaic platforms, platforms for gas or oil exploration, platforms for hydrogen production, etc., to anchor them by a steel foundation structure (e.g. a steel monopile foundation, steel tripod foundations, steel tripile foundation, steel jacket foundation and the like) that extends at least to the underwater bottom on or in the underwater ground, in particular a seabed, there are increasing considerations to install floatable respectively buoyant offshore structures, for example floatable power generation devices, such as floatable offshore wind turbines or floatable photovoltaic platforms. Further, offshore structures comprising a concrete foundation are installed.

One reason for using floatable offshore structures is the possibility of installing such offshore structures in areas with a large water depth, for example, of more than 150 meters.

A buoyant offshore structure and floatable offshore structure, respectively, may comprise at least one floatable foundation having at least one floating body. The offshore structure, in particular, an offshore device supported by the foundation, may have at least one submarine (power) cable connector. In variants, the submarine cable connector may also be arranged at the foundation. A submarine cable connector can be configured to connect a submarine (power cable) with the electrical device of the offshore structure.

For example, a transformer device with at least one transformer, a wind power device, a photovoltaic device, a hydrogen production device, etc. may be installed as an offshore device of an offshore structure.

For offshore structures, a grounding connection and earthing connection, respectively, is generally required, in particular as lightning protection. A conventional offshore structure with a steel foundation has a natural connection to earth potential, i.e. to the underwater ground. However, a floatable offshore structure, but also non-floatable offshore structures installed on the seabed via a concrete foundation or the like may not have such a (sufficient) natural connection to earth potential.

This is all the more true as non-metallic anchor and mooring lines, respectively, are increasingly used in floatable offshore structures for anchoring the floatable offshore structure at the underwater ground. Mooring lines connecting offshore structures to the underwater ground are increasingly made out of non-conducting synthetic materials (e.g. Kevlar/Dyneema). In order to provide an earthing connection to the underwater ground also in these cases, it is known from the prior art to install additional earthing connection lines connecting the earthing system of the offshore structure with the earth potential, i.e. the underwater ground.

This significantly increases the effort of installation and maintenance of an offshore structure (without a steel foundation or the like) with an earthing system connected to the earthing potential, i.e. the underwater ground.

### SUMMARY OF THE INVENTION

Therefore, the object of the present application is to provide a possibility to reduce the effort of installation and maintenance of an offshore structure (without a steel foundation or the like) with an earthing system connected to the earthing potential, i.e. the underwater ground.

The object is solved according to a first aspect of the application by an earthing connection device according to claim 1 for an earthing system of an offshore structure. The earthing connection device comprises at least one earthing connector. The earthing connector is configured to be inserted in an underwater ground in an installed state of the earthing connection device. The earthing connection device comprises at least one electrical connector electrically connected to the at least one earthing connector. The at least one electrical connector is configured to connect the electrical connector with at least one armoring wire of at least one armoring layer of a submarine cable.

A further aspect of the application is an earthing set for an earthing system of an offshore structure, in particular, a floatable offshore structure. The earthing set comprises at least one submarine cable comprising at least one phase conductor configured to transmit electrical power and at least one armoring layer with at least one armoring wire. The earthing set comprises at least one previously described earthing connection device.

A still further aspect of the application is an offshore structure, in particular, a floatable offshore structure. The offshore structure comprises at least one earthing system. The offshore structure comprises at least one electrical device connected to at least one submarine cable of the offshore structure (e.g. via a submarine (power) cable connector). The submarine cable comprises at least one phase conductor configured to transmit electrical power and at least one armoring layer with at least one armoring wire. The earthing system comprises at least one electrical terminal. The electrical terminal is connected to the at least one armoring wire of the submarine cable. The offshore structure comprises at least one previously described earthing connection device. The at least one electrical connector of the earthing connection device and the at least one armoring wire are connected to each other (in an installed state of the earthing connection device).

A still further aspect of the application is an offshore structure system, in particular, a floatable offshore structure system. The offshore structure system comprises a first offshore structure (as previously described) and at least one further offshore structure (as previously described). The first offshore structure is connected to the at least one further offshore structure by the submarine cable. The at least one electrical connector of the earthing connection device and the at least one armoring wire of the submarine cable are connected to each other. Preferably, both the first offshore structure and the further offshore structure share a single earthing connection device.

A still further aspect of the application is a use of the previously described earthing set for connecting an earthing system of an offshore structure, in particular, a previously described offshore structure, to the underwater ground.

A still further aspect of the application is an installation method for installing a previously described earthing set, comprising:
determining a submarine cable section to be connected to the earthing connection device (in particular, to be enclosed by the housing of the earthing connection device) based on the water depth at the installation point of the offshore structure,
mounting the earthing connection device at the determined submarine cable section, and
laying the submarine cable with the earthing connection device, and in particular,
inserting (preferably anchoring) at least one earthing connector of the earthing connection device into the underwater ground at the installation point.

In contrast to the prior art, according to the present application, the effort of installation and maintenance of an offshore device (without a steel foundation or the like) with an earthing system connected to the earthing potential, i.e. the underwater ground, is significantly reduced by providing an earthing connection device connectable to the armoring layer of the submarine cable, wherein the earthing connection device comprises an earthing connector electrically connected with the underwater ground.

In particular, according to the present application it has been recognized that the at least one armoring layer of a submarine cable (provided anyway) can be used as an earthing connection from an earthing system of the offshore structure to the earthing potential, i.e. the underwater ground, if the earthing connection device according to the application provides a means to establish a (permanent) electrical connection between the armoring layer and the underwater ground at the underwater floor.

The earthing connection device provides a (permanent) electrical connection between a (conventional) earthing system of an offshore structure and the earthing potential, i.e. the underwater ground (e.g. a seabed), in the installed state of the earthing connection device.

An offshore structure according to the present application is, in particular, an offshore structure without a natural electrical connection to the earthing potential. Preferably, an offshore structure according to the present application is an offshore structure without a non-floatable steel foundation. According to a preferred embodiment, the offshore structure is a floatable offshore structure. In other variants, the offshore structure may be an offshore structure with a concrete foundation or the like.

A floatable offshore structure may comprise a floatable foundation comprising at least one floating body. A floating body and buoyant body, respectively, is independently buoyant, in particular, due to its buoyancy by displacement according to Archimedes' principle. Floating bodies may, for example, be hollow and filled with a gas, e.g. air, or with a light solid. In particular, the floatable foundation may substantially form the floating body.

Preferably, the floatable foundation may be a so-called barge foundation, semi-submersible foundation, spar foundation and/or tension leg platform (TLP) foundation. It shall be understood that other types of floatable foundations may be provided in other variants of the application.

An offshore structure comprises at least one submarine cable and is connected with at least one submarine cable, respectively. A submarine cable according to the application is, in particular, a submarine power cable configured to transmit electrical energy and power, respectively. The submarine cable comprises at least one phase conductor (e.g. made of copper, aluminum or the like). Preferably, the submarine power cable may comprise three phase conductors for transmitting electrical power.

Further, the submarine cable comprises at least one armoring layer (surrounding the at least one phase conductor). An armoring layer of a submarine cable is generally configured to protect the cable elements surrounded by the at least one armoring layer. A submarine cable may preferably comprise a plurality of armoring layers (e.g. between 2 and 4).

The at least one armoring layer comprises at least one armoring wire and armoring rope, respectively. Preferably, the at least one armoring layer comprises a plurality of armoring wires. At least one armoring wire may be made of an electrically conductive material. In particular, at least one armoring wire is made of metal, such as copper or steel. In variants of the application, at least some armoring wires may be made of another material, such as carbon fiber, glass fiber, etc.

It has been recognized that the at least one (electrically conductive) armoring layer used as a cable protector can also be used as an electrical connection between the earthing system of the offshore structure and the earthing potential.

Further, the submarine cable may comprise additional cable elements. For instance, the submarine cable may comprise at least one optical conductor integrated in the submarine power cable as an (optical) communication conductor. It shall be understood that a submarine power cable may include further cable elements, such as at least one insulation layer, at least one shielding layer, an outer jacket, filler material and/or the like.

The submarine cable of the present application is preferably a medium-voltage submarine power cable (e.g., between 3 kV and 30 kV) or a high-voltage submarine power cable (e.g., between 60 kV and 525 kV). It shall be understood the voltage may be further increased in future developments. The power capacity of a submarine cable according to the application is preferably between 3 MW and 2.5 GW. In addition, a submarine power cable may also be equipped for data transmission.

In particular, a submarine cable according to the application may run from a submarine cable connector of an offshore structure to the underwater ground and then through the underwater ground in a specific depth range. If a further structure connected to the submarine power cable is also an offshore structure, the submarine cable may then run from the underwater ground to a further submarine cable connector of the further (floatable) offshore structure. If the further structure connected to the submarine cable is an onshore structure, the submarine cable may run substantially through the ground to the further submarine cable connector of the onshore structure.

The at least one submarine cable connector may be configured to connect a submarine cable to one or more electrical device(s) of the offshore structure. The offshore structure may preferably comprise a foundation configured to support at least one offshore device comprising the at least one electrical device.

The offshore structure may comprise the offshore device disposed on the foundation. This offshore device may comprise the at least one submarine cable connector. Preferably, the offshore device may comprise at least one electrical device in form of an electrical power generation device or an electrical consumer. Exemplary and non-exhaustive offshore devices comprise substation devices (comprising at least one electrical transformer), wind power devices (e.g. comprising a tower, nacelle, rotor, generator, etc.), photovoltaic devices (preferably comprising a plurality of photovoltaic modules), and hydrogen production devices, in particular a water electrolysis device.

According to one embodiment, the earthing connection device may comprise at least one housing. The housing may comprise at least one housing wall. The housing is configured to (partially or fully) enclose a submarine cable section of the submarine cable in the installed state of the earthing connection device.

An installed state of the earthing connection device means, in particular, that the submarine cable is connected to an electrical connector of the earthing connection device and that the earthing connection device is arranged at the underwater ground. In particular, the earthing connection device can be anchored in the underwater ground, e.g. at least partially buried in the underwater ground.

The earthing connection device and box, respectively, comprises at least one earthing connector configured to be inserted (e.g. piled) in the underwater ground in said installed state. By a (electrically conductive) earthing connector inserted, in particular, anchored, drilled and/or piled, in the underwater ground, an electrical connection to the earthing potential can be provided. Preferably, a plurality of earthing connectors (e.g. between 2 and 6) can be provided in the earthing connection device.

The earthing connection device comprises at least one electrical connector. This connector is preferably (partially or fully) housed in the housing and electrically connected to the at least one earthing connector. In other words, an electrically conductive connection is provided from the at least one electrical connector via the earthing connector to the earthing potential and underwater ground, respectively.

The electrical connector is connected with the earthing connector. If there is no housing, the electrical connector can merge into the earthing connector. In other words, an electrical connector and an earthing connector can be formed by one piece and in particular from an electrically conductive material.

The least one electrical connector is configured to (electrically and in particularly galvanically) connect the electrical connector with the at least one armoring wire of the at least one armoring layer of the submarine cable. Hereby, an electrical connection from the earthing system of the offshore structure via the at least one armoring wire of the at least one armoring layer, the electrical connector and the earthing connector to the underwater ground can be established.

In particular, the at least one armoring layer can be cut (e.g. inside the housing) in such a way that the at least one armoring wire can be connected to the electrical connector or is connected in the installed state. Due to the housing, the submarine cable is (well) protected. In particular, a housing can make it easier to handle offshore.

According to a preferred embodiment of the earthing connection device according to the application, the electrical connector may be configured to mechanically and electrically connect the electrical connector with the at least one armoring wire, preferably with a plurality (e.g. all) armoring wires, of the at least one armoring layer of the submarine cable. By providing an electrical connector which is also configured to provide a mechanical connection (e.g. a frictional connection) with the submarine cable, in particular, with the armoring layer, an additional mechanical connector can be omitted.

Further, according to a further preferred embodiment of the earthing connection device according to the application, the earthing connection device may comprise a plurality of electrical connectors. In particular, at least one electrical connector for each armoring layer can be provided. In some embodiments, two electrical connectors may be provided for each armoring layer of the submarine cable. An even more reliable electrical connection (and preferably mechanical connection) can be provided.

According to a particularly preferred embodiment of the earthing connection device according to the application, the at least one electrical connector (preferably all electrical connectors) may be a press plate connector with at least two press plate halves (made of an electrically conductive material). In a connected state of the press plate connector, the at least one armoring wire (in particular, a cut end of the armoring wire) may be held pressed between the at least two press plate halves. Thereby, a mechanical and electrical connection can be established in a simple and reliable manner. In other variants of the application, the at least one electrical connector may be a press cone connector with at least one press cone. The press cone connector functions in a similar manner as a press plate connector.

In an open state of the press plate connector (or press cone connector), the at least one armoring wire, preferably a plurality of armoring wires, (in particular, the respective open armoring wire end(s)) can be inserted between the press plate halves (or press cones). Then, the press plate halves (or press cones) can be moved relative to each other to the (described) connected state, e.g. by using a suitable tool. In a simple manner, the at least one armoring wire can be electrically and preferably mechanically connected to the press plate connector (or a press cone connector).

According to a further embodiment of the earthing connection device according to the application, at least one press plate halve (of the at least two press plate halves) or at least on press cone may be directly attached to a housing wall of the housing thereby providing an electrically and mechanically connection to the housing wall of the housing. In particular, the at least one housing wall and the at least one press plate halve (or press cone) can be made of an electrically conductive material. The housing wall may provide an electrical connection to the at least one earthing connector. A reliable electrical connection from the armoring wire(s) via the press plate halve (or press cone) and the housing wall to the at least one earthing connector can be provided.

Preferably, the press plate halve (or press cone) directly attached to the housing wall may be integrally formed with the housing wall. In particular, only one of the two press plate halves may be movable. The non-movable press plate halve can be directly attached to a housing wall of the housing, in particular, can be integrally formed with the housing wall.

According to an embodiment of the application, at least one electrical line may be arranged between the electrical connector and the earthing connector. According to a further embodiment of the earthing connection device according to the application, at least one electrical line may be arranged between at least one press plate halve (and press cone, respectively) (in particular, a non-movable press plate halve (or press cone)) and the housing wall. Preferably, the electrical line, in particular, in form of a (flexible) cable, can be arranged additionally to the direct attachment of the least one press plate halve (or press cone) to the housing wall.

In particular, the press plate halve or press cone may be integrally formed with the housing wall and there may be an additional electrical line, in particular, in form of a (flexible) cable between said press plate halve and said housing wall. A particular reliable electrical connection can be provided. In variants of the application, there may be two or more electrical lines (e.g. with different plate connection points) between said press plate halve and said housing wall.

Furthermore, according to a further embodiment of the earthing connection device according to the application, the at least one electrical line may extend from a plate connection point to a housing connection point. The housing connection point may be (directly) adjacent to the earthing connection point of the earthing connector attached to the housing and housing wall, respectively. Adjacent to the earthing connection point means, in particular, that the housing connection point is essentially arranged on the opposite housing wall side as the earthing connection point. The housing connection point may be arranged on the inner side of the housing wall and the earthing connection point on the respective outer side of the housing wall.

As already described, the earthing connector can be piled and/or anchored into the underwater ground in order to establish a connection to the earthing potential. According to a preferred embodiment of the earthing connection device according to the application, the at least one earthing connector may be formed as an earthing anchor, in particular, an earthing pile. The earthing anchor is, in particular, configured to anchor the housing in the underwater ground in the installed state and intended state, respectively. The at least one earthing anchor may protrude from the bottom of the housing and enclosure, respectively. For example, the earthing anchor, in particular, an earthing pile, can have a length between 0.5 m and 2.5 m (e.g. 1 m). A good electrical connection and at the same time a secure anchoring of the earthing connection device according to the application can be provided.

According to a further embodiment of the earthing connection device according to the application, at least the housing, in particular, the at least one housing wall of the housing, can be made of a metallic and corrosion-resistant material. The metallic and corrosion-resistant material is, in particular, selected from the group, comprising:
stainless steel,
aluminum,
copper,
brass,
galvanized steel, or
a combination of at least two of said materials.

Preferably, further or other elements (e.g. the earthing connector, the electrical connector, etc.) of the earthing connection device can be made of at least one of said materials.

Stainless steel has a resistance to rust, corrosion (and a wide variety of other reactions) which makes it ideal for use in the present earthing connection device. The surface of aluminum forms an oxide film, which is created by chemical reactions with water and oxygen. This oxide layer is about five to ten nanometers thick. This protective layer prevents the metal from rusting in water, which prevents corrosive reactions, and thus, aluminum is a preferred material in the present earthing connection device. The particular advantage of copper and brass is their good electrical conductivity properties. Galvanized steel is particularly suitable for a use in salt water.

According to a further embodiment of the earthing connection device according to the application, the housing may be a modular housing comprising at least two housing modules configured to allow the housing to be mounted around the submarine cable section of the submarine cable. In particular, the at least two housing modules may be configured to allow the housing to be mounted at the submarine cable section prior to laying the submarine cable on the underwater ground.

In an open state of the housing modules a submarine cable section of the submarine cable can be inserted in the housing and the at least one electrical connector can be connected with the at least one (cut and separated, respectively) armoring wire of the at least one armoring layer of the submarine cable. Upon establishment of the electrical (and mechanical) connection between the at least one electrical connector and the at least one armoring wire, the at least two housing modules can be moved in the closed state. The housing may comprise a locking mechanism configured to lock the at least two housing modules with each other in the closed state.

Preferably, the at least two housing modules may be formed as two housing halves connected to each other by at least one hinge. The two housing halves are movable between an open state and a closed state, wherein in the closed state, the housing encloses the submarine cable section. An earthing connection device can be provided which allows a simple installation of the submarine cable section to the earthing connection device.

According to a further embodiment of the earthing connection device according to the present application, the housing may comprise at least one cable inlet opening and at least one cable outlet opening (in the at least one housing wall). The at least one cable inlet opening and the at least one cable outlet opening may be configured (and arranged in the respective housing walls, respectively) to allow the submarine cable to extend through the housing in an installed state, in particular, in such a way that the submarine cable section is enclosed by the housing.

According to a further embodiment of the earthing connection device according to the application, the housing (in particular, the at least two housing modules in the closed state) may be configured to essentially prevent a water exchange between the water inside the housing and the surrounding water. In one embodiment, a seal may be provided, e.g. between the edges of the at least two housing modules and/or at the cable inlet opening and/or the cable outlet opening. However, preferably a seal can be dispensed with as long as a water exchange is essentially prevented.

As described, the at least one armoring layer of the at least one submarine cable can be used as an electrical connection between the earthing system of the offshore structure and the earthing connection device of the application. The earthing system of the offshore structure is, in particular, required to provide a lightning protection system and/or an earth potential for the at least one electrical device of the offshore structure.

In particular, in order to (electrically) connect the earthing system of the offshore structure to the at least one armoring wire of the submarine cable, the offshore structure, in particular, the earthing system may comprise at least one terminal configured to connect said terminal (and hence the earthing system of the offshore structure) to the at least one armoring wire. Preferably, a plurality of terminals can be provided. In particular, for each armoring layer, a respective terminal may be provided. By way of example, a terminal can be formed in a similar (e.g. identical) manner as a previously described electrical connector.

Furthermore, as already described, an offshore structure system may comprise two or more (previously described) offshore structures. In particular, in an offshore wind farm, there may be at least one string (preferably, a plurality) of offshore wind turbines connected in series to each other and to a substation.

According to a preferred embodiment of the offshore structure system according to the present application, both the first offshore structure and the further offshore structure share a single earthing connection device. In particular, the first and the further offshore structure are connected to each other by a (single) submarine cable, wherein only a single earthing connection device is installed to said submarine cable.

As described, the earthing set of the application can be used to connect an earthing system of an offshore structure to an earthing potential, i.e. the underwater ground.

The earthing set can be installed by using the following method. The method may comprise determining the submarine cable section to be connected to the earthing connection device, in particular, the electrical connector. For instance, the method can comprise determining the submarine cable section to be enclosed by the housing of the earthing connection device, based on the water depth at the installation point of the offshore structure. The submarine cable section can be selected such that in the installed state, the earthing connection device is arranged on or in the underwater ground (at a specific area of the underwater ground).

Upon the determining of the submarine cable section, the earthing connection device can be attached/mounted to the determined submarine cable section (e.g. as explained above). This can be made, e.g., on the installation vessel at the installation site of the offshore structure. Then, the submarine cable can be laid (in a conventional way).

Upon laying the submarine cable, the at least one earthing connector can be anchored, in particular, piled into the underwater ground, in particular, to establish an electrical connection to the underwater ground and preferably to anchor the earthing connection device to the underwater ground. It shall be understood that further or other anchoring means can be provided.

For instance, the earthing connection device and the submarine cable can be laid down on the seabed with a vessel crane or similar. An ROV (remotely operated vehicle) or similar can assist to install the at least one earthing connector and electrode, respectively, that is piled into the underwater ground, in particular, a seabed.

The features of the earthing connection devices, earthing sets, offshore structures, offshore structure systems, uses and methods can be freely combined with one another. In particular, features of the description and/or the dependent claims, even when the features of the dependent claims are completely or partially avoided, may be independently inventive in isolation or freely combinable with one another.

### BRIEF DESCRIPTION OF THE DRAWINGS

These and other aspects of the present patent application become apparent from and will be elucidated with reference to the following figures. The features of the present application and of its exemplary embodiments, as presented above, are understood to be disclosed also in all possible combinations with each other.

In the figures show:

FIG. 1 shows a schematic view of an embodiment of an earthing connection device according to the present application,

FIG. 1a shows a schematic view of an example of a submarine cable,

FIG. 2 and FIG. 2a show a schematic view of an embodiment of an offshore structure according to the present application with an embodiment of an earthing connection device according to the present application,

FIG. 3 shows a schematic view of an embodiment of an offshore structure system according to the present application with an embodiment of an earthing connection device according to the present application, and

FIG. 4 shows a diagram of an embodiment of an installation method according to the present application.

### DETAILED DESCRIPTION OF THE INVENTION

Like reference signs in different figures indicate like elements. In addition, z denotes the vertical direction and x denotes a horizontal direction.

In the following embodiments, offshore wind turbines and offshore substations are depicted as offshore structures. However, the following explanations can be transferred to other offshore structures, such as offshore photovoltaic structures, offshore hydrogen production structures, etc.

Further, in the following, the described embodiments of an earthing connection device, the earthing connection device always comprise an optional housing. However, the housing can also be omitted in not shown embodiments. In particular, if the used materials of the submarine cable (in particular, the armoring layer(s)) are made of a corrosion-resistant material the housing can be omitted. The armor layer can be, for example, made of stainless steel or another corrosion-resistant and electrical conductive material so the housing would not be necessary.

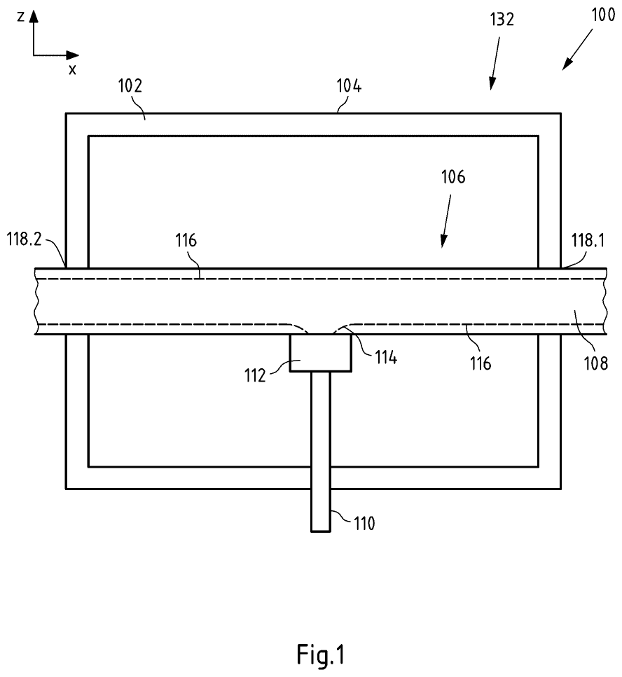

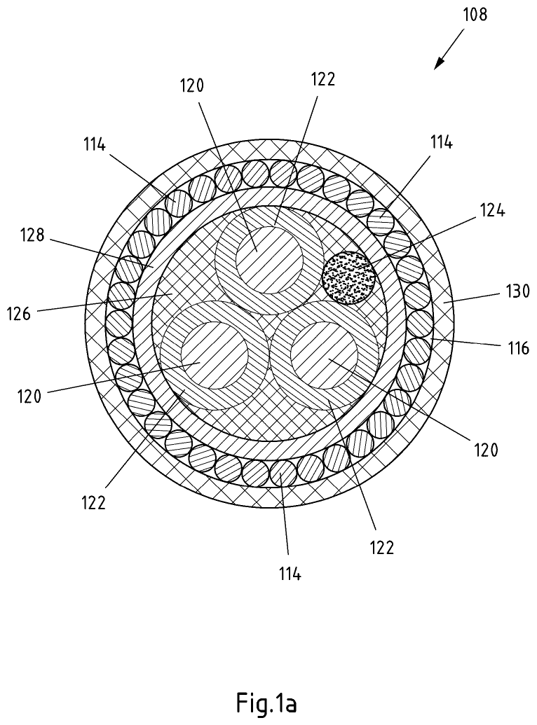

FIG. 1 shows a schematic view of an embodiment of an earthing connection device 100 according to the present application. The earthing connection device 100, in particular, an earthing connection box 100, serves for providing a permanent electrical connection between an earthing system of a (not shown) offshore structure and the (not shown) underwater ground via a submarine cable 108 connected to the offshore structure.

As can be seen, the earthing connection device 100 comprises at least one optional housing 102, in particular, with at least one housing wall 104. The housing 102 is configured to (partially or totally) enclose a submarine cable section 106 of the submarine cable 108 in an installed state of the earthing connection device 100.

The submarine cable section 106 is, in particular, the section of the submarine cable 108 which is (permanently) enclosed by the housing 102 in the installed state of the earthing connection device 100. At least the housing 102, in particular, the at least one housing wall, can be made of a metallic and corrosion-resistant material, such as stainless steel, aluminum, copper, brass, galvanized steel, and/or the like.

Furthermore, the earthing connection device 100 comprises at least one earthing connector 110. The earthing connector 110, for instance, also made of metallic and corrosion-resistant material, such as stainless steel, aluminum, copper, brass, galvanized steel, and/or the like, is configured to be inserted in the underwater ground in the installed state.

In addition to the earthing connector 110, the earthing connection device 100 comprises at least one electrical connector 112. As can be seen from FIG. 1, the electrical connector 112 is housed in the housing 102 and electrically connected to the at least one earthing connector 110. By way of example, the earthing connector 110 can extend through an opening of the housing wall 104 to the electrical connector 112. The submarine cable 100 and the earthing connection device 100 may form an earthing set 132.

If there is no housing, the electrical connector can merge into the earthing connector.

The shown housing 102 comprise at least one cable inlet opening 118.1 and at least one cable outlet opening 118.2 (in the at least one housing wall 104). The at least one cable inlet opening 118.1 and the at least one cable outlet opening 118.2 may be configured and arranged in the housing 102 to allow the submarine cable 108 to extend through the housing 102 in an installed state, in particular, in such a way that the submarine cable section 106 is enclosed by the housing 102.

As schematically indicated in FIG. 1, the at least one electrical connector 112 is configured to connect the electrical connector 112 with at least one armoring wire 114 of at least one armoring layer 116 of the submarine cable 108.

FIG. 1a shows a schematic and more detailed (sectional) view of an example of a submarine cable 108 according to the application which can generally be used with an earthing connection device 100 according to the present application.

The depicted submarine cable 108 is, in particular, a medium voltage cable or a high voltage cable. The submarine (energy) cable 108 may preferably have a power capacity between 3 MW and 2.5 GW.

In particular, the submarine cable 108 may be a MV (medium voltage) submarine cable 108 comprising a power capacity between 3 MW and 70 MW, preferably between 9 MW and 60 MW, or a HV (high voltage) submarine cable 108 comprising a power capacity between 70 MW and 2.5 GW, preferably between 360 MW and 2500 MW.

The illustrated submarine cable 108 has three phase conductors 120 configured to transmit electrical energy (or power or current). In other variants, only one phase conductor may be provided. A phase conductor 120 can be formed in one piece, but also in several pieces. A phase conductor 120 can be round or sector-shaped and/or be formed as a single or multiple wire.

Around each phase conductor 120, it may be advantageous to first form a not shown inner conductive layer (e.g. a non-metallic, conductive sheath, e.g. as a conductor screen layer), then an insulating layer 122 (e.g. an insulation screen) and then a (not shown) outer conductive layer (e.g. consisting of a non-metallic sheath in combination with a metallic part) as, for example, core protection layer.

An optional optical conductor cable 124 can also be provided as a further conductor 124. The optical conductor cable 124 can be coupled with a (not shown) temperature detection device to monitor the temperature in the submarine cable. It can (alternatively or additionally) be used for data transmission.

In order to obtain an essentially circular cable cross-section for the submarine cable 108, the submarine cable 108 usually has a filler material 126 (also called fillers).

A so-called bedding layer 128 can be arranged between the at least one armoring layer 116 and the previously described cable elements (e.g. phase conductor, optical phase conductor cable etc.) arranged inside the submarine cable 108, in order to provide, in particular, a protective layer 120 between the at least one armoring layer 116 and the cable elements in the inside.

A bedding layer (not shown) can also be arranged between two adjacent armoring layers and between an armoring layer 116 and the outer sheath 130.

An armoring layer 116 can be preferably formed by several armoring wires 114 and ropes 114, respectively. At least one of the armoring wires 114 is made of an electrically conductive material. For example, one armoring wire 114 may be made of metal (e.g. steel). At last one further armoring wire 114 can be made of a composite material (e.g. carbon fibre, glass fibre etc.) and/or also of metal (e.g. steel).

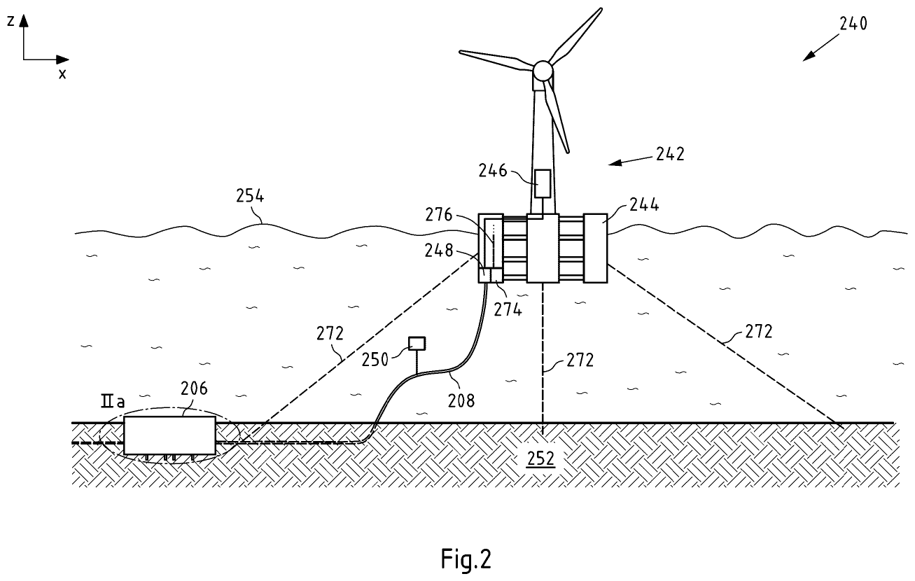

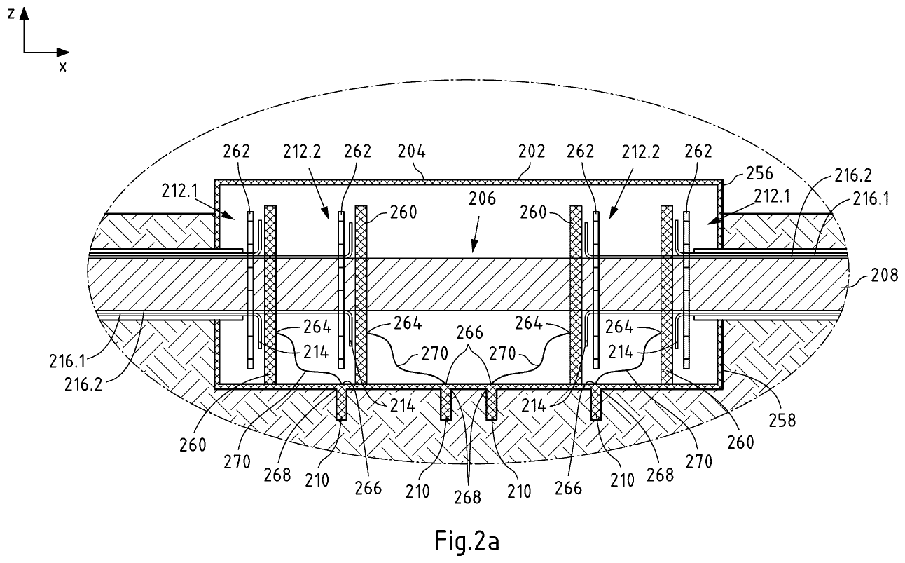

FIG. 2 shows a schematic view of an embodiment of an offshore structure 240 according to the present application with an embodiment of an earthing connection device 200 according to the present application. In order to avoid repetitions, in the following only the differences between the embodiment of FIG. 1 and the embodiment of FIG. 2 are essentially described.

The shown offshore structure 240 is a floatable offshore structure 240, in particular, a floatable wind turbine 240. The floatable offshore structure 240 comprises at least one offshore device 242 in form of the wind turbine 242 and at least one floatable foundation 244 configured to support the offshore device 242. The floatable foundation 244 may comprises at least one (not shown) floating body. Further, the floatable foundation 244 is anchored to the underwater ground 252, e.g. a seabed 252, via mooring lines 272, e.g. made of a non-conductive material, such as Kevlar.

The offshore device 242 comprises at least one electrical device 246 (e.g. a power generator and/or a power consumer). The at least one electrical device 246 is connected to the submarine cable 208 by means of a submarine cable connector 248.

As further indicated in FIG. 2, the offshore structure 240 comprises an earthing system 276 with at least one terminal 274. The shown terminal 274 is configured to connect the terminal 274 (and thus the earthing system 276) to at least one armoring wire 214 of the submarine cable 208. In the present example, the submarine cable 208 comprises two armoring layers 216.1, 216.2 each with a plurality of armoring wires 214. For example, two terminals 274 can be provided. A terminal 274 can be formed similar to an electrical connector 212, which will be explained hereinafter.

As can be seen from FIG. 2, the offshore structure 240 comprise an earthing connection device 200. The earthing connection device 200 is shown in the installed state, i.e. the earthing connection device 200 is coupled with the submarine cable and anchored in the underwater ground 252.

In the present example, the earthing connection device 200 comprises a modular housing 202 with at least two housing modules 256, 258 configured to be movable between an open state and a closed state (which is shown in FIG. 2).

Furthermore, the shown earthing connection device 200 comprises at least one earthing connector 210 (by way of example, four earthing connectors 210 are shown). The at least one earthing connector 210 is in particular formed as an earthing anchor 210, preferably, an earthing pile 210, protruding from the underside of the housing 202. As shown, the at least one earthing connector 210 may be integrally formed with the housing 202 and the housing wall 204, respectively.

The shown earthing connection device 200 comprises four electrical connectors 212.1, 212.2 as seen in FIG. 2a. In particular, two first electrical connectors 212.1 and two second electrical connectors 212.2. In other variants of the application, there may be only one first electrical connector 212.1 and only one second electrical connector 212.2 (each for a respective armoring layer 216.1, 216.2).

Each electrical connector 212.1, 212.2 is formed as a press plate connector 212.1, 212.2 with at least two press plate halves 260, 262. In other variants, there may be a press cone connector with two press cones.

One of the press plate halves 260, 262, i.e. press plate halve 260, is presently directly attached to a housing wall 204 thereby providing an electrically and mechanically connection to the housing wall 204 of the housing 202. Preferably, the press plate halve 260 is integrally formed with the housing wall 204.

The respective other press plate halve 262 can be movable between an open state and position, respectively, and a closed (or pressed) state and position, respectively. In the open state, the armoring wires 214 (and armoring wire ends, respectively) of a respective armoring layer 216.1, 216.2 can be inserted between the press plate halves 260, 262. Then, the respective other press plate halve 262 can be moved such that the at least one armoring wire 214 is held in a pressed manner by the press plate connector 212.1, 212.2.

Optionally, at least one electrical line 270 can be arranged between a respective press plate halve 260 and a housing wall 204. Preferably, a respective electrical line 270 may extend from a plate connection point 264 to a housing connection point 266, wherein the housing connection point 266 is, in particular, adjacent to the earthing connection point 268 of the respective earthing connector 210 attached to the housing 202. As can be seen from FIG. 2, the respective earthing connection point 268 and the corresponding respective housing connection point 266 are located on opposite sides of the housing wall 204.

As described above, the housing 202 is, in particular, a modular housing with at least two housing modules 256, 258 which may be configured to allow the housing 202 to be mounted at (and to, respectively) the submarine cable section 206 prior to laying the submarine cable 208 on or in the underwater ground 252.

In an open state of the housing modules 256, 258 the submarine cable section 206 can be inserted into the housing 202 and the at least one electrical connector 212.1, 212.2 can be connected with the at least one cut armoring wire 214, as described hereinbefore. Upon establishment of the electrical (and mechanical) connection between the at least one electrical connector 212.1, 212.2 and the at least one armoring wire 214, the at least two housing modules 256, 258 can be moved in the closed state. The housing 202 may comprise a (not shown) locking mechanism configured to lock the at least two housing modules 256, 258 with each other in the closed state. Preferably, the at least two housing modules 256, 258 may be formed as two housing halves 256, 258 connected to each other by at least one (not shown) hinge.

It is noted that reference sign 250 indicates the water surface and reference sign 252 a buoy.

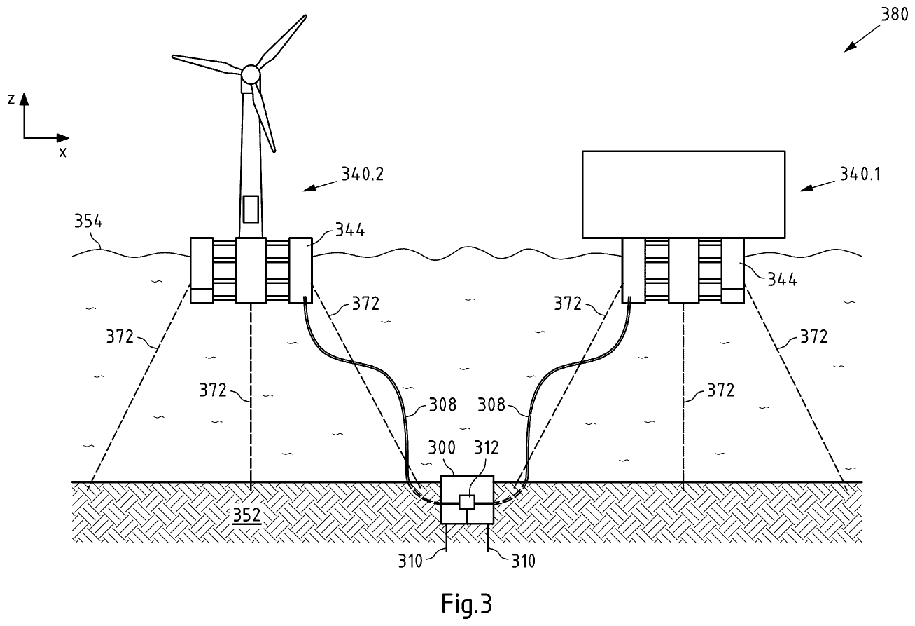

FIG. 3 shows a schematic view of an embodiment of an offshore structure system 380 according to the present application with an embodiment of an earthing connection device 300 according to the present application. For avoiding repetitions, essentially only the differences to the previous embodiments are described below. For the other features, it is referred to the above embodiments.

The offshore structure system 380 can be a floatable offshore structure system 380 with a plurality of floatable offshore structures 340.1, 340.2. By way of example, a floatable offshore wind farm 380 is depicted with a floatable substation 340.1 and at least one floatable wind turbine 340.2. The floatable wind turbine 340.2 can be formed e.g. as the offshore structure shown in FIG. 2.

The first offshore structure 340.1 is connected to the at least one further offshore structure 340.2 by a (single) submarine cable 308. The at least one electrical connector 312 of the earthing connection device 300 and the at least one armoring wire 314 of the submarine cable 308 are connected to each other. In particular, it has been recognized that a single earthing connection device 300 is sufficient to provide a connection to the earthing potential for both the earthing system of the first offshore structure 340.1 and the earthing system of the further offshore structure 340.2.

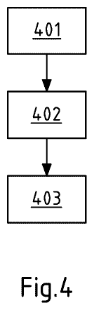

FIG. 4 shows a diagram of an embodiment of an installation method according to the present application. The installation methods serves to install and mount, respectively, the earthing connection device (e.g. according to FIGS. 1, 2 and/or 2) to a submarine cable and to lay the resulting arrangement.

In a first step 401, a determining of the submarine cable section to be enclosed by the housing of the earthing connection device is performed, based on the water depth at the installation point of the offshore structure.

In step 402, an installing and mounting, respectively, of the earthing connection device at (and to, respectively) the determined submarine cable section.

Afterwards, the submarine cable with the earthing connection device is laid (step 403). Then the earthing connection device is inserted, in particular, piled into the underwater ground such that it is permanently anchored in the underwater ground. Thus, a permanent connection from an earthing system of an offshore structure (without a steel foundation connected to the underwater ground) to the earthing potential, i.e. the underwater ground.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An earthing connection device for an earthing system of an offshore structure, comprising:
at least one earthing connector configured to be inserted in an underwater ground in an installed state of the earthing connection device,
at least one electrical connector electrically connected to the at least one earthing connector,
wherein the least one electrical connector is configured to connect the electrical connector with at least one armoring wire of at least one armoring layer of a submarine cable
at least one housing configured to enclose a submarine cable section of the submarine cable in the installed state of the earthing connection device,
wherein the at least one electrical connector is housed in the housing,
wherein the at least one earthing connector is formed as an earthing anchor in the form of an earthing pile having a length between 0.5 m and 2.5 m,
wherein the earthing anchor is configured to anchor the housing in the underwater ground in the installed state.

2. The earthing connection device according to claim 1, wherein
the at least one electrical connector is a press cone connector with at least one press cone or a press plate connector with at least two press plate halves.

3. The earthing connection device according to claim 2, wherein
at least one press cone or at least one press plate halve is directly attached to a housing wall thereby providing an electrically and mechanically connection to the housing wall of the housing,
the housing wall provides an electrical connection to the at least one earthing connector.

4. The earthing connection device according to claim 2, wherein
at least one electrical line in form of a cable is arranged between at least one press cone or at least one press plate halve and the housing wall.

5. The earthing connection device according to claim 4, wherein
the electrical line extends from a plate connection point to a housing connection point,
the housing connection point is adjacent to the earthing connection point of the earthing connector attached to the housing.

6. The earthing connection device according to claim 1, wherein
at least the housing is made of a metallic and corrosion-resistant material.

7. The earthing connection device according to claim 1, wherein
the housing is a modular housing comprising at least two housing modules configured to allow the housing to be mounted around the submarine cable section of the submarine cable.

8. The earthing connection device according to claim 1, wherein
the housing comprises at least one cable inlet opening and at least one cable outlet opening,
the at least one cable inlet opening and at least one cable outlet opening are configured to allow the submarine cable to extend through the housing in an installed state.

9. The earthing connection device according to claim 1, wherein
the housing is configured to essentially prevent a water exchange between the water inside the housing and the surrounding water.

10. An earthing set for an earthing system of a floatable offshore structure, comprising:
at least one submarine cable comprising at least one phase conductor configured to transmit electrical power and at least one armoring layer with at least one armoring wire, and
at least one earthing connection device according to claim 1.

11. An offshore structure, comprising
at least one earthing system,
at least one electrical device connected to at least one submarine cable of the offshore structure,
wherein the submarine cable comprises at least one phase conductor configured to transmit electrical power and at least one armoring layer with at least one armoring wire,
wherein an electrical terminal of the earthing system is connected to the at least one armoring wire,
at least one earthing connection device according to claim 1, and
wherein the at least one electrical connector of the earthing connection device and the at least one armoring wire are connected to each other.

12. Offshore structure system, comprising
a first offshore structure according to claim 11 and at least one further offshore structure according to claim 11,
wherein the first offshore structure is connected to the at least one further offshore structure by the submarine cable,
wherein the at least one electrical connector of the earthing connection device and the at least one armoring wire of the submarine cable are connected to each other.

13. Use of the earthing set according to claim 10 for connecting an earthing system of an offshore structure to the underwater ground.

14. The earthing connection device according to claim 6, wherein
the metallic and corrosion-resistant material is selected from the group, comprising:
stainless steel,
aluminum,
copper,
brass,
galvanized steel.

15. The offshore structure according to claim 11, wherein
the offshore structure is a floatable offshore structure.

16. The offshore structure system according to claim 12, wherein
the offshore structure is a floatable offshore structure.

17. Use of an earthing set for connecting an earthing system of an offshore structure according to claim 11 to an underwater ground, the earthing set comprising:
at least one submarine cable comprising at least one phase conductor configured to transmit electrical power and at least one armoring layer with at least one armoring wire, and
at least one earthing connection device comprising:
at least one earthing connector configured to be inserted in an underwater ground in an installed state of the earthing connection device,
at least one electrical connector electrically connected to the at least one earthing connector,
wherein the least one electrical connector is configured to connect the electrical connector with at least one armoring wire of at least one armoring layer of the submarine cable
at least one housing configured to enclose a submarine cable section of the submarine cable in the installed state of the earthing connection device,
wherein the at least one electrical connector is housed in the housing,
wherein the at least one earthing connector is formed as an earthing anchor in the form of an earthing pile having a length between 0.5 m and 2.5 m,
wherein the earthing anchor is configured to anchor the housing in the underwater ground in the installed state.
